(19) United States
(12) Patent Application Publication
(10) Pub. No.: US 2025/0254676 A1
(43) Pub. Date: Aug. 7, 2025

(54) TECHNOLOGIES FOR BEAM MANAGEMENT

(71) Applicant: Apple Inc., Cupertino, CA (US)

(72) Inventors: Haitong Sun, Saratoga, CA (US); Dawei Zhang, Saratoga, CA (US); Huaning Niu, San Jose, CA (US); Wei Zeng, Saratoga, CA (US); Hong He, San Jose, CA (US); Chunxuan Ye, San Diego, CA (US); Ankit Bhamri, Haar Bavaria-Bayern (DE)

(73) Assignee: Apple Inc., Cupertino, CA (US)

(21) Appl. No.: 19/007,383

(22) Filed: Dec. 31, 2024

Related U.S. Application Data
(60) Provisional application No. 63/549,399, filed on Feb. 2, 2024.

(51) Int. Cl. H04W 72/044

(52) U.S. Cl. CPC H04W 72/046

(57) ABSTRACT

The present application relates to devices and components including apparatus, systems, and methods for supporting user equipment (UE)-assisted beam management.

### CROSS-REFERENCES TO OTHER APPLICATIONS

This application claims priority to U.S. Provisional Application No. 63/549,399, for “TECHNOLOGIES FOR BEAM MANAGEMENT” filed on Feb. 2, 2024, which is herein incorporated by reference in its entirety for all purposes.

### TECHNICAL FIELD

This application relates generally to communication networks and, in particular, to technologies for user equipment (UE)-assisted beam management.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a network environment in accordance with some embodiments.

FIG. 3 illustrates a beam refinement procedure in accordance with some embodiments.

FIG. 4 illustrates a rotation state in accordance with some embodiments.

FIG. 5 illustrates a report configuration in accordance with some embodiments.

FIG. 6 illustrates an operation flow/algorithmic structure in accordance with some embodiments.

FIG. 7 illustrates an operation flow/algorithmic structure in accordance with some embodiments.

FIG. 8 illustrates an operation flow/algorithmic structure in accordance with some embodiments.

FIG. 9 illustrates an operation flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects, or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

3GPP TSs describe operations that rely on transmission configuration indicator (TCI) states to facilitate communications. 3GPP Release 15 (R15) and Release 16 (R16) introduced legacy TCI framework. The beam indication for downlink (DL) channels or signals may use TCI states, and the beam indication for uplink (UL) channels or signals may use spatial relations. Beam indication for different channels or signals, e.g., control channels, shared channels, or different reference signals, may use different mechanisms, e.g., radio resource control (RRC) signaling, medium access control (MAC) control element (CE), or downlink control information (DCI).

3GPP Release 17 (R17) and Release 18 (R18) introduced a unified TCI framework. The unified TCI state may refer to a TCI state that applies to multiple downlink or uplink channels. For example, a unified downlink (DL) TCI state may be applied to both a downlink data channel (e.g., a physical downlink shared channel (PDSCH)) and a downlink control channel (e.g., a physical downlink control channel (PDCCH), while a unified uplink (UL) TCI state may be applied to both an uplink data channel (e.g., a PUSCH) and an uplink control channel (e.g., PUCCH). The R17 and R18 unified TCI state supports two modes. In a first mode, a joint unified TCI state is applicable to both uplink and downlink channels. In a second mode, a DL TCI state is used for downlink channels, and a separate UL TCI state is used for uplink channels.

To support the two modes of R17 and R18, RRC signaling may be used to configure a UE with a pool of unified TCI states by signaling one or two lists. If only one list is used to configure the pool, the list will be a DL-or-joint-TCI-state list (dl-OrJoint-TCIStateList) having TCI states that will be used as joint unified TCI states. If two lists are used to configure the pool, the first list (dl-OrJoint-TCIStateList) will provide unified DL TCI states, and a second list, UL TCI state list (ul-TCI-StateList), will provide unified UL TCI states.

For example, in R17 unified TCI framework, up to 128 TCI states may be configured in dl-OrJointTCI-StateList for joint TCI mode, up to 128 TCI states may be configured in dl-OrJointTCI-StateList for DL unified TCI in separate TCI mode, and up to 64 UL TCI state may be configured in ul-TCI-StateList.

In the R17 and R18 unified TCI framework, the TCI states of a configured pool may be indicated/activated in one of two ways. In a first way, a MAC control element (CE) is used to indicate either a joint unified TCI state of the configured pool or to indicate one unified DL TCI state and one unified DL TCI state. In a second way, the MAC CE may activate a plurality of joint unified TCI states or a plurality of sets of unified UL/DL TCI states. Subsequently, DCI may be used to indicate one of the activated TCI/TCI sets that is to be used.

Two schemes of TCI state indication may be supported. In scheme 1, a common TCI indication may configure the TCI state for multiple channels or signals. For example, a common TCI may apply to dedicated channels, e.g., PDCCH, PDSCH, PUCCH, or PUSCH. The common TCI may apply to signals, e.g., aperiodic channel state information (CSI) reference signal (RS) for beam management (BM), or sounding reference signal (SRS) for codebook precoding (CB), non-codebook precoding (NCB), antenna switching (AS), or beam management (BM). The network may configure the UE with channels and signals associated with a common TCI state.

In scheme 2, a dedicated TCI indication may be used for a channel or a reference signal (RS). For example, a dedicated TCI indication may be used for periodic CSI-RS, semi-persistent CSI-RS, aperiodic CSI-RS for tracking, common PDCCH, or common PDSCH. The TCI state for some channels or signals may be configured with both schemes 1 and 2, while the TCI state for some channels or signals may be configured only with scheme 1 or scheme 2.

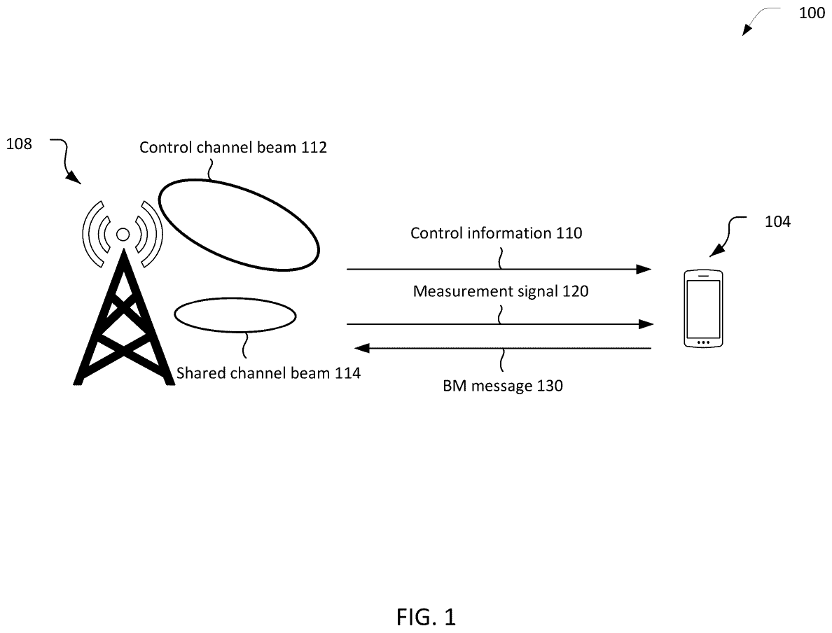

FIG. 1 illustrates a network environment 100 in accordance with some embodiments. The network environment 100 may include user equipment (UE) 104 communicatively coupled with base stations 108 of a radio access network (RAN). The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The base station 108 may send control information 110 to the UE 104. The base station 108 may use different signaling or messages to send the control information 110 to the UE 104. The base station may use radio resource control (RRC), medium access control (MAC), or physical layer (PHY) signaling to send control information 110 to the UE 104. For example, the base station may use RRC information elements (IE) or RRC configuration or reconfiguration signaling, MAC control element (CE), or downlink (DL) control information (DCI) to send control information 110 to the UE 104.

The UE 104 may receive and process the control information 110. The control information 110 may include configuring one or more DL TCI states, each associated with a DL transmission beam. For example, the base station 108 may configure the UE 104 with one or more control channel beams, e.g., control channel beam 112. The base station 108 may associate the control channel beam 112 with a physical downlink control channel (PDCCH). Additionally or alternatively, the base station 108 may configure the UE 104 with one or more shared channel beams, e.g., shared channel beam 114. The base station 108 may associate the shared channel beam 114 with a physical downlink shared channel (PDSCH).

In some instances, a control channel beam may have a larger beam width than a shared channel beam. In some instances, a beam failure is more likely to occur to a beam with a given beam width than to another beam with a wider beam width. For example, the channel quality of a narrow beam may deteriorate or fluctuate while the channel quality of a wide beam remains satisfactory. While legacy systems include a beam failure recovery mechanism for the control channel, it is desired to recover from the loss of beams for the shared channel.

The base station 108 may configure the UE 104 with one or more shared channel beam 114. The UE may also be configured, e.g., via implementation or by the base station 108, with one or more receiving beams.

Beam management may include operations performed by the base station 108 and the UE 104, including beam measurement and report, beam indication, and beam failure recovery. The beam failure recovery may include beam failure detection, new candidate beam identification, beam failure report, and beam failure response. For example, the UE 104 may measure the measurement signal 120. The UE 104 may detect a beam failure or compute a report based on processing the beam measurement signal 120. The UE 104 may generate a beam management message 130 to inform the base station 108 of the measurement report or detection of the beam failure.

Beam measurement and report may include channel measurement and reporting quantities associated with the channel measurement. The beam management may utilize the channel state information (CSI) framework for beam measurement and report.

In some instances, for DL beam measurement, the base station 108 may send the measurement signal 120 to the UE 104. The measurement signal 120 may be a CSI-RS. The UE 104 may receive and process the measurement signal 110 and compute report quantities. For example, report quantities may be layer 1 (L1)-reference signal received power (RSRP) or L1-signal to interference and noise ratio (SINR) may be used for beam management. Additionally or alternatively, link adaptation (LA) report quantities such as channel quality indicator (CQI), precoding matrix indicator (PMI), rank indicator (RI), layer indicator (LI), CSI-reference signal (RS) resource indicator (CRI), or synchronization signal (SS)/physical broadcast channel (PBCH) block (SSB) resource indicator (SSBRI) may be used for beam management.

In a legacy system, the base station 108 may use RRC signaling to configure the UE 104 with a list of TCI states for PDSCH. Each TCI state may be associated with a beam. In some instances, one or more TCI states may be associated with the same beam. For example, the base station 108 may use the RRC tci-StatesToAddModList IE in PDSCH-Config configuration, which may be included in RRC configuration or reconfiguration messages. In one example, the base station 108 may configure 64 or 128 TCI states at the UE 104.

The base station 108 may activate a subset of TCI states at the UE 104. The base station may include an indication of the activated TCI states in a MAC CE. For example, the base station 108 may activate 8 TCI states of the 64 or 128 configured TCI states by MAC CE.

The base station 108 may dynamically select one of the active TCI states for PDSCH transmission to the UE 104. The base station 108 may include an indication of the selected TCI state in the DCI. For example, the TCI field in a DCI, e.g., DCI format 1_1 or 1_2, may indicate the selected TCI state for PDSCH transmission.

In some instances, the network, e.g., the base station 108, may control the beam management. The base station 108 may use CSI-RS or SSB for channel measurement. For example, the base station 108 may use periodic CSI-RS or SSB to obtain periodic, semi-persistent, or aperiodic CSI reports. In other examples, the base station 108 may use semi-persistent CSI-RS to obtain semi-persistent or aperiodic CSI reports. In some other examples, the base station 108 may use aperiodic CSI-RS to obtain aperiodic CSI reports.

Similarly, base station 108 may use UL sounding reference signal (SRS) resource sets for UL beam management. The SRS resource set may include a field to indicate that it is used for beam management. In some instances, the UL beam management may rely on beam correspondence in which the transmitter, e.g., the UE 104, and the receiver, e.g., the base station 108, may maintain the same beam direction. The DL reference signal may be used to indicate the TCI state or beam for UL channels or signals.

Controlling the beam management by the base station may be based on a measurement by the UE, detection of a beam failure, reporting to the base station, receiving configuration or activation of a candidate beam (TCI state), and switching the beam to the candidate beam. The beam quality variation may be due to the UE 104 movement and the environment change near the UE 104. The UE 104 is measuring and monitoring beam quality. The UE 104 may be equipped with sensors and circuitry that can be used to further improve beam management accuracy, latency or robustness. Therefore, in some situations, the UE may be in a better position than the base station 108 to identify a proper DL or UL beam. The UE 104 may provide its preference for the candidate beam for beam management.

In some embodiments, the UE 104 may assist the base station 108 in beam management. The UE 104 may detect PDSCH beam failure and initiate PDSCH beam failure recovery. The UE 104 may trigger aperiodic CSI-RS measurement for beam refinement. The UE 104 may detect device rotation and determine whether to apply power control. The UE 104 may also request the base station 108 to disable one or more DL beams.

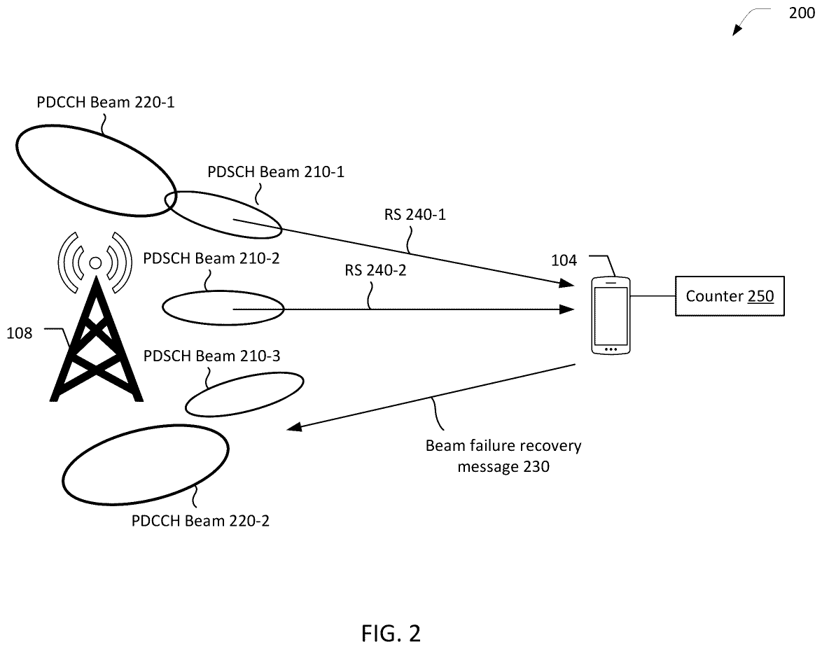

FIG. 2 illustrates a network environment 200 in accordance with some embodiments. Network environment 200 is an example where the base station 108 has configured three beams for PDSCH, e.g., PDSCH beam 210-1, PDSCH beam 210-2, and PDSCH beam 210-3, collectively beams 210. The base station 108 may configure the UE 104 with the TCI states associated with the beams 210.

The base station 108 may activate one or more beams of the beams 210. For example, the base station 108 may activate PDSCH beam 210-1 and PDSCH beam 210-2 by including an indication of the TCI states associated with these beams in a MAC CE.

The TCI state associated with a beam may include or be associated with one or more reference signals. In some instances, the UE 104 may be configured to perform measurements on reference signals associated with configured TCIs. In other instances, the UE 104 may be configured to perform measurement on the reference signals associated with activated TCIs.

The base station may configure PDCCH beams 220, e.g., PDCCH beam 220-1 or PDCCH beam 220-2. The PDCCH beams 220 has a beam width that is larger than the beam width of the PDSCH beams 210.

The UE 104 may perform channel measurements for each activated TCI using a reference signal associated with the TCI state, e.g., RS 240-1 associated with PDSCH beam 210-1 or RS 240-2 associated with PDSCH beam 210-2. The UE may measure the RSRP or SINR quantities for each activated TCI state. In some instances, the UE may detect that a TCI state is ‘invalid’ or ‘failed’ by determining that the measured RSRP associated with the TCI state is lower than a configured or predetermined RSRP threshold. Alternatively, or additionally, the UE may detect that a TCI state is ‘invalid’ or ‘failed’ by determining that the measured SINR associated with the TCI state is lower than a configured or predefined SINR threshold. The UE 104 may be configured, e.g., using RRC signaling, with the values of the RSRP or SINR thresholds. Additionally, or alternatively, the 3GPP specifications may define the RSRP or SINR thresholds.

In some embodiments, the UE 104 may detect an instance of PDSCH beam failure has occurred (on a cell, e.g., a primary cell or a secondary cell) when the UE 104 determines that every active TCI state (of that cell) is invalid, e.g., their SINR is lower than a threshold, or their RSRP is lower than another threshold. In response to detecting an instance of PDSCH beam failure, the UE 104 may initiate PDSCH beam failure recovery.

The UE 104 may be in a transient state, e.g., rotation, which may cause a single PDSCH beam management measurement quantity, e.g., RSRP or SINR, to drop below the corresponding threshold. The UE 104 may trigger the PDSCH beam failure recovery procedure. However, the transient state may quickly resolve. It is desired that the likelihood of false alarms be reduced when detecting PDSCH beam failure.

To reduce the likelihood of false alarms in detecting the PDSCH beam failure, the UE 104 may detect multiple consecutive instances of the PDSCH beam failures before triggering PDSCH beam failure recovery procedure. The UE 104 may use a counter 250 to track the number of consecutive instances of the PDSCH beam failures. For example, the UE 104 may start by setting the counter 250 to zero. The UE 104 may next detect, for the first time, that all the activated TCI states are invalid. The UE 104 may determine the first instance of the PDSCH beam failure based on detecting that all the active TCI states are invalid and increment the counter 250. The UE 104 may perform another measurement, detect that all the activated TCI states are invalid, determine the second instance of PDSCH beam failure, and increment the counter 250 again. The UE 104 may initiate the PDCH beam failure recovery when the counter 250 reaches a configured or predefined threshold. If the UE 104 detected that at least one activated TCI state was valid before the counter 250 reached the threshold, then the UE 104 may reset the counter 250 to zero.

In some embodiments, once the UE 104 detects the PDSCH beam failure and initiates the PDSCH beam failure recovery, the UE 104 may determine a PDSCH candidate beam. The UE 104 may need a PDSCH candidate beam to receive PDSCH associated with the PDSCH beam failure recovery procedure.

In some instances, the UE 104 may be configured with the PDSCH candidate beam. The PDSCH candidate beam may be the list of TCI states configured by RRC for PDSCH. For example, the TCI states in tci-StatesToAddModList IE in PDSCH-Config configuration of RRC signaling, e.g., configuration or reconfiguration signaling. Additionally, or alternatively, the PDSCH candidate beam may be independently configured by the base station 108 via RRC signaling.

In some embodiments, the PDSCH candidate beam may be shared among serving cells, e.g., the PDSCH candidate beam for one serving cell may be configured to be transmitted and measured on another serving cell. The UE 104 may be configured with one or more thresholds such that when candidate beam quality, e.g., RSRP or SINR, is higher than the threshold, the beam is determined to be valid.

In some embodiments, when UE 104 detects PDSCH beam failure and initiates the beam failure recovery procedure, the UE 104 may send a PDSCH beam failure recovery request 230 to the base station 108. The UE 104 may generate the PDSCH beam failure recovery request 230 and send it to the base station 108 even if UE 104 does not detect any valid PDSCH candidate beam. Alternatively, the UE 104 may generate the PDSCH beam failure recovery request 230 and send it to the base station 108 only when UE 104 detects at least one valid PDSCH candidate beam.

In some embodiments, when PDSCH beam failure occurs on a primary cell, e.g., PCell or primary serving cell (PSCell), the UE 104 may transmit the PDSCH beam recovery request 230 on the physical random access channel (PRACH).

When PDCH beam failure occurs on a secondary cell, e.g., SCell, the UE 104 may transmit the PDSCH beam recovery request 230 over MAC CE on other cells, e.g., the primary cell. The UE 104 may send the PDSCH beam recovery request 230 using the physical uplink control channel (PUCCH) or PRACH in the failed secondary cell. The UE 104 may use the PDCCH beam (TCI state), e.g., PDCCH beam 220-1 or PDCCH beam 220-2, to receive PDSCH.

For example, after UE 104 declares PDSCH beam failure and transmits the PDSCH beam recovery request 230 to the base station 108, the UE 104 may use the strongest PDCCH beam, e.g., PDCCH beam with the largest RSRP or SINR, to receive PDSCH.

In response to the PDSCH beam recovery request 230, the base station 108 may send an acknowledgment to the UE 104. The UE 104 may receive and process the acknowledgment. The acknowledgment may include the identified new PDSCH candidate beam that UE 104 can use to receive PDSCH. Subsequently, the base station 108 may configure the UE 104, e.g., via RRC reconfiguration, with new PDSCH TCI states.

In one embodiment, the UE 104 may send the PDSCH beam failure recovery request 230 using MAC CE. The base station 108 may send the acknowledgment using a DCI. The DCI may schedule the same hybrid automatic repeat request (HARQ) process that is associated with the MAC CE that carried the PDSCH beam failure recovery request 230. The DCI may also include a new data indicator (NDI) field. In general, if the value of the NDI field is changed from ‘0’ to ‘1’ or from ‘1’ to ‘0’ it may mean that the downlink assignment may include new data. When the value of the NDI field is not changed, e.g., the value remained unchanged at ‘1’ or ‘0’, it may mean that the downlink assignment is for retransmission. For the first downlink assignment, regardless of the value of the NDI field, the UE 104 may assume that the value of the NDI is toggled, e.g., if the value of the NDI field is ‘1’ the UE 104 may assume that it has changed from ‘0’ to ‘1’ and if the value of the NDI field is ‘0’ the UE 104 may assume that it has changed from ‘1’ to ‘0.’

In one embodiment, the UE 104 may send the PDSCH beam failure recovery request 230 PUCCH or PRACH. The UE 104 may assume a configured or predefined duration for receiving the acknowledgment. For example, the UE 104 may assume a duration of 28 symbols from sending the PDSCH beam failure recovery request 230 until receiving an acknowledgment from the base station 108. During this period, the UE may monitor PDCCH for a DCI, e.g., PDCCH associated with the strongest PDCH beam. If the UE 104 does not receive an acknowledgment during this period, the UE 104 may assume that the base station 108 has not successfully received the PDSCH beam failure recovery request 230 and may retransmit it.

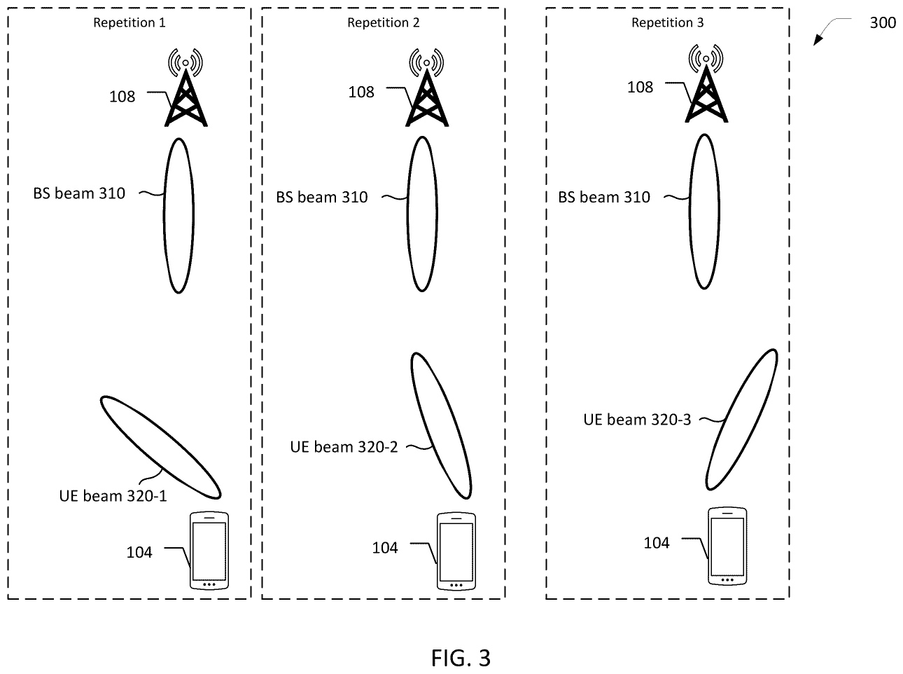

FIG. 3 illustrates a beam refinement procedure 300 in accordance with some embodiments. The beam refinement procedure 300 is an example of a receiver beam sweeping procedure.

The UE 104 and the base station 108 may identify a pair of transmitter and receive beams that are aligned. However, the UE device may rotate, causing the misalignment between the transmitter and receiver beams. Such rotation or UE 104 movements may be unpredictable to the base station 108 but may be known to the UE 104. To facilitate the beam tracking and refinement, the UE 104 may generate and send a request to the base station 108 to trigger transmission of an aperiodic CSI-RS.

The UE 104 may send the request to the base station 108 via PRACH. Alternatively, the UE 104 may send the request to the base station 108 using PUCCH. For example, the UE 104 may include the aperiodic CSI-RS request in an UL scheduling request (SR).

In other instances, the UE 104 may send the request to the base station 108 using MAC CE. If the UE 104 has an UL grant, the UE 104 may use the UL grant to send the MAC CE. However, if the UE 104 does not have an UL grant, the UE 104 may user SR to request an UL grant.

In some embodiments, the UE 104, together with the aperiodic CSI-RS trigger, may include in the request an indication of whether the UE prefers UE side receiver beam sweep, base station side transmitter beam sweep, or both. For example, the request may include a non-zero-power (NZP)-CSI-RS-ResourceSet with repetition field having the value ‘ON’ to indicate UE side receiver beam sweep. Alternatively, the request may include the NZP-CSI-RS-ResourceSet with repetition field having the value ‘OFF’ to indicate the base station side transmitter beam sweep.

The refinement procedure 300 illustrates the UE side receiver beam sweep. In all repetitions, e.g., repetitions 1, 2, and 3, the base station 104 may use the same beam, e.g., base station beam 310. At each repetition, the base station 104 may send a reference signal, e.g., a NZP-CSI-RS, using the resources associated with the aperiodic CSI-RS. At each repetition, the UE 104 may change its receiver beam to receive and process the transmitted reference signal. For example, the UE may use UE beam 320-1 in repetition 1, UE beam 320-2 in repetition 2, and UE beam 320-3 in repetition 3. The UE 104 may compare the measured quantities, e.g., RSRP or SINR, at each repetition and select the strongest beam, e.g., having the largest RSRP or SINR, as the receiver beam.

In some instances, the UE 104 may send a UE capability report to the base station 108. The UE capability message may include a field that may indicate the maximum number of receiver beams at the UE 104. For example, the UE 104 may report the number of receiver beams in the maxNumberRxBeam field of the UE capability report. The value of this field may indicate the preferred number of NZP-CSI-RS resource repetitions per CSI-RS resource set.

In other instances, the UE 104 may indicate the number of repetitions or aperiodic CSI-RS resources in the request message. For example, the number of aperiodic CSI-RS resources in the NZP-CSI-RS-ResourceSet with repetition set to ‘ON’ may be equivalent to the number of receiver beams that the UE 104 plans to sweep for receiver beam refinement.

In some embodiments, the UE 104 may include in the request for aperiodic CSI-RS an indication of a transmitter beam that should be used for aperiodic CSI-RS transmission. The UE 104 may select the transmitter beam from the set of activated TCI states, among the configured list of TCI states, or from the list of candidate beams for beam failure recovery.

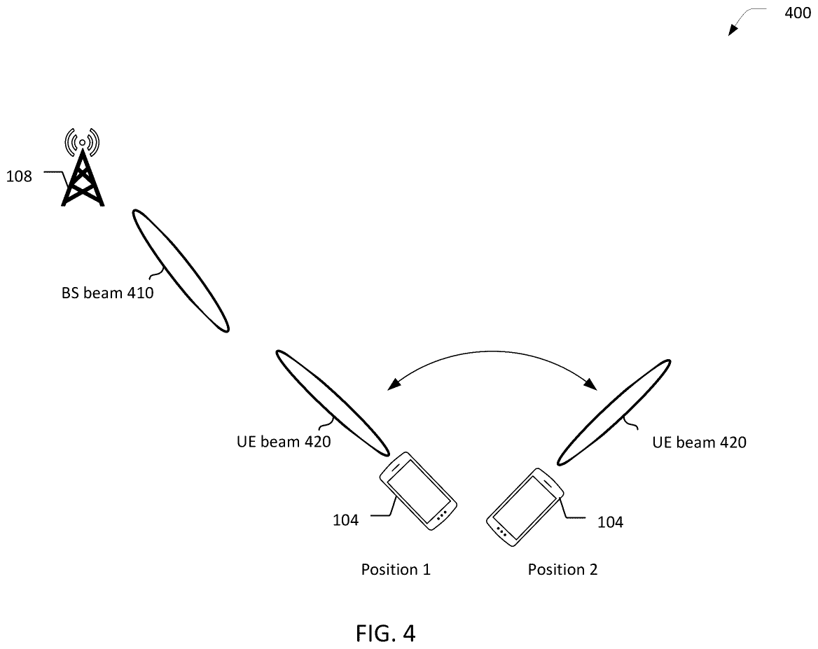

FIG. 4 illustrates a rotation state 400 in accordance with some embodiments. The rotation state 400 may impact the UE power control. In some examples, the UE 104 may estimate the path loss based on measuring downlink signals. When UE 104 rotates and changes its orientation from position 1 to position 2, its receiver beam 420 may lose its alignment with the base station 104 transmitter beam 410. The misalignment between the transmitter and receiver beams may cause the UE 104 to attribute the reduction in the received power to an increase in the path loss. The UE 104 may use the path loss estimate for its uplink transmission power control. A larger path loss estimate may result in an increase in allocated power.

In some embodiments, the UE may not follow open-loop power control when one or more of the following conditions are met. The first condition may be when the UE detects significant beam quality change, e.g., a change in SINR, RSRP, or received signal strength indicator (RSSI), together with the detection of UE rotation. The base station or the 3GPP specifications may configure or define the threshold for determining whether the beam quality change is significant. For example, the UE 104 may determine whether the change in beam quality is significant if the reduction in SINR or RSRP is larger than a threshold, e.g., 5 decibels (dB) or 10 dB.

A second condition may be when the path loss estimate increases significantly, e.g., by 5 dB or 10 dB.

A third condition may be when the UE 104 is not able to perform an accurate beam compensation procedure.

When UE 104 detects that it is in fast rotation (unstable state), the UE 104 may use omnidirectional beams. The UE 104 may wait until the UE 104 is in a stable state, e.g., a stable rotation state. The UE 104 may selectively adopt beamforming results based on the stable rotation state.

In some embodiments, when the UE 104 detects that its beam is rotating or unstable, the UE may generate and send a request to the base station 108. The request may include an indication that the base station 108 uses a wide beam, e.g., a beam with a wide beam width. The UE may send the request for the base station 108 to use a wide beam on a PRACH or PUCCH, using MAC CE, or via RRC, e.g., UE assistance information (UAI).

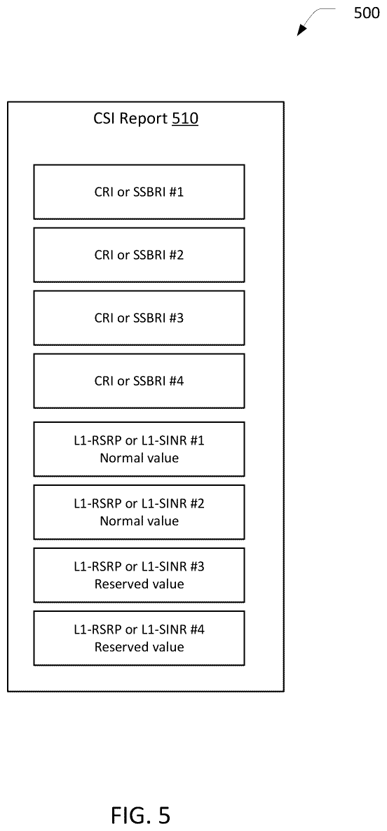

FIG. 5 illustrates a report configuration 500 in accordance with some embodiments. The resource and report configuration 500 is an example of information elements and data structures used for CSI report 510 associated with active beams. The CSI report 510 may be part of regular report, e.g., report certain value, such as received value as RSRP or SINR.

The CSI report 510 may include one or more indications associated with one or more resources. CSI report 510 includes CRI or SSBRI #1-#4. For example, the CIR or SSBRI #1 may be associated with one CSI-RS or SSB resource.

The CSI report 510 may also include one or more reports, e.g., L1-RSRP or L1-SINR #1-#4. The reports may take normal values or revised values. For example, L1-RSRP or L1-SINR #1 and #2 have normal values and L1-RSRP or L1-SINR #3 and #4 have reserved value. The value in each report may be an indication of the measurement, e.g., a quantized value of the measurement. In some instances, the value field may indicate whether the value is a normal value, e.g., within the range of measurement, or it is a reserved value. For example, a reserved value may indicate that the measurement is too low or too high.

In one example, a reserved value may indicate that the CSI-RS resource and the associated TCI state are invalid. The base station may interpret that the UE recommends disabling the associated TCI state.

In another example, the CSI report 510 may indicate whether the indicated beam should be disabled for the receiver, transmitter, or both.

In some embodiments, when the UE detects that an activated or previously reported beam is unsuitable, e.g., rotating or being unstable, the UE may report to the base station that those beams may be disabled.

The UE may detect that the beam is unsuitable based on the device movement, e.g., movements that may position a panel of the device close to a body (e.g., human body). The UE may recommend that all beams related to the panel be disabled due to large power back-off or blockage. In other instances, the UE may detect that the beam is unsuitable based on the device rotation or the device being in an unstable state, e.g., large and unpredictable fluctuation in SINR or RSRP measurements.

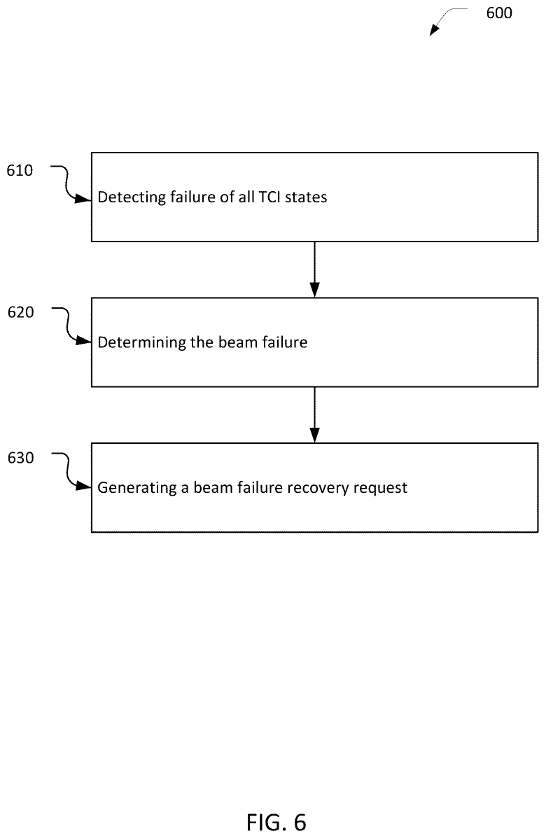

FIG. 6 illustrates an operation flow/algorithmic structure 600 in accordance with some embodiments. The operation flow/algorithmic structure 600 may be performed or implemented by a base station such as, for example, the base station 108 or the base station 1100, or components thereof, for example, baseband processor circuitry 1104A.

The operation flow/algorithmic structure 600 may include, at 610, detecting a failure of all TCI states. The UE may detect that a TCI state fails or is invalid when the SINR associated with the TCI state is below a preconfigured or predetermined first threshold. The UE may detect that a TCI state fails or is invalid when the RSRP associated with the TCI state is below another preconfigured or predetermined second threshold.

The UE may be configured with the first or second thresholds, e.g., via RRC signaling.

The operation flow/algorithmic structure 600 may include, at 620, determining a beam failure. The UE may determine a beam failure based on detecting that each active TCI has failed.

The UE may utilize a counter to determine beam failure. Each time that an instance of beam failure is detected, the counter is incremented. Each time that at least one TCI state is detected to be valid, the counter is reset to zero. The UE may determine a PDSCH beam failure when the counter reaches a preconfigured or predetermined threshold. The threshold may be preconfigured via RRS signaling or predetermined in 3GPP specifications.

The operation flow/algorithmic structure 600 may include, at 630, generating a beam failure recovery request. The UE may send the beam failure recovery request to the base station in response to determining the beam failure.

The UE may send the beam failure recovery request on PUCCH or PRACH. When the UE determines that all the active TCI states of one cell are invalid, the beam failure recovery request may be included in a MAC CE of another cell.

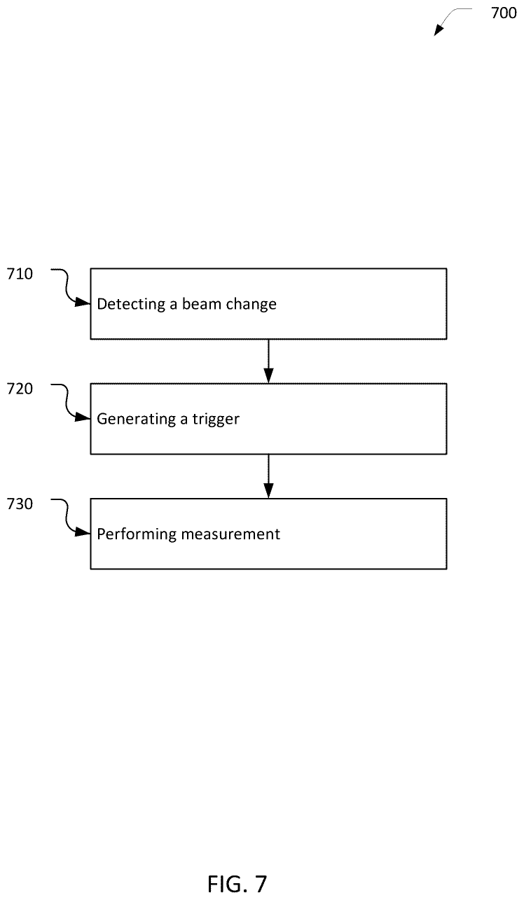

FIG. 7 illustrates an operation flow/algorithmic structure 700 in accordance with some embodiments. The operation flow/algorithmic structure 700 may be performed or implemented by a base station such as, for example, the base station 108 or the base station 1000; or components thereof, for example, baseband processor circuitry 1004A.

The operation flow/algorithmic structure 700 may include, at 710, detecting a beam change. The beam change may be a change in beam quality, e.g., measured SINR or RSRP.

The operation flow/algorithmic structure 700 may include, at 720, generating a trigger. The UE may generate a trigger based on the detection of the beam change. The trigger may include an indicator requesting transmission of an aperiodic CSI-RS.

The UE may transmit the trigger on PRACH or PUCCH using MAC CE or

scheduling request. The trigger may indicate receiver beam sweep, transmitter beam sweep, or both.

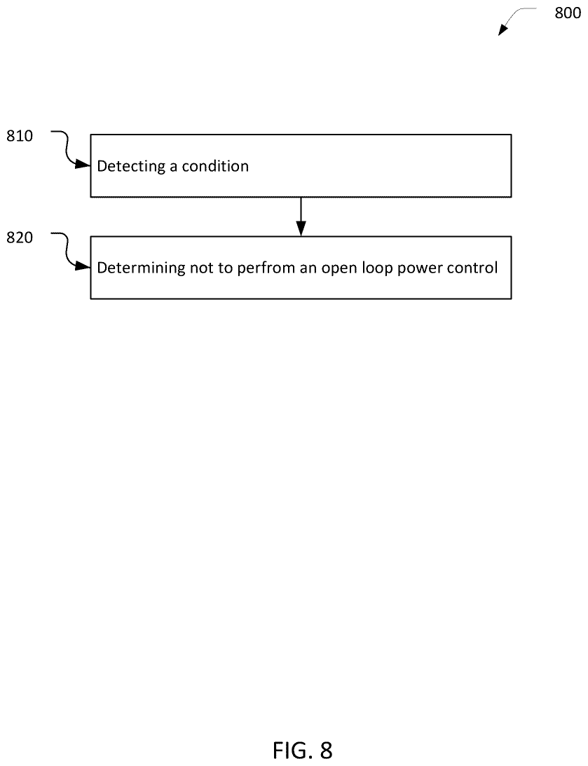

FIG. 8 illustrates an operation flow/algorithmic structure 800 in accordance with some embodiments. The operation flow/algorithmic structure 800 may be performed or implemented by a base station such as, for example, the base station 108 or the base station 1000; or components thereof, for example, baseband processor circuitry 1004A.

The operation flow/algorithmic structure 800 may include, at 810, detecting a condition. The condition may be a rotation of the UE. The UE may select to use an omnidirectional beam.

The operation flow/algorithmic structure 800 may include, at 820, determining whether or not to perform the open-loop power control or follow the open-loop power control procedure as described in the 3GPP specifications.

The UE may send a message to the base station requesting to use a DL beam with a wide beam width.

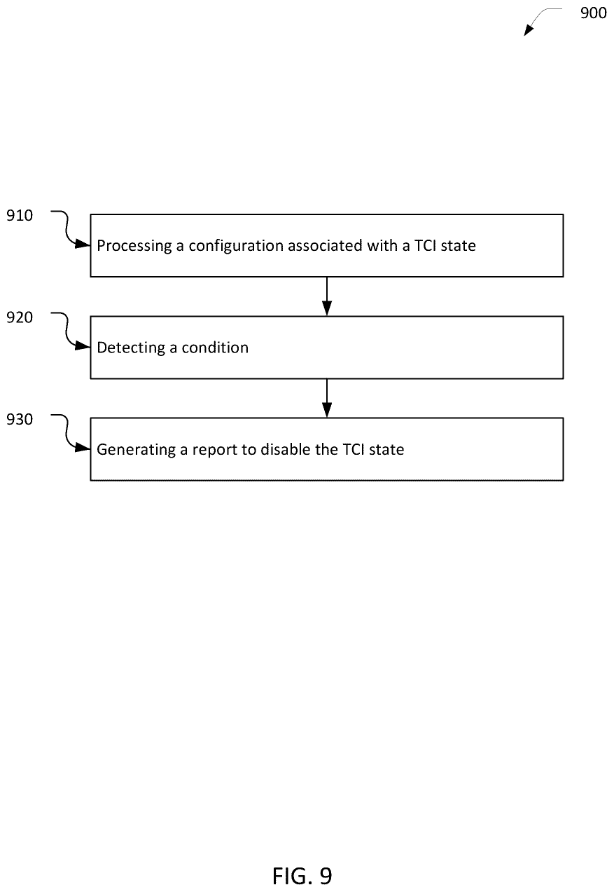

FIG. 9 illustrates an operation flow/algorithmic structure 900 in accordance with some embodiments. The operation flow/algorithmic structure 900 may be performed or implemented by a base station such as, for example, the base station 108 or the base station 1000; or components thereof, for example, baseband processor circuitry 1004A.

The operation flow/algorithmic structure 900 may include, at 910, processing a configuration associated with a TCI state. The UE may be configured with one or more TCI states. The UE may be configured, e.g., via MAC CE, to activate a subset of one or more TCI states.

The operation flow/algorithmic structure 900 may include, at 920, detecting a condition. The condition may be detecting a power back off or a blockage associated with the TCI state, detecting a rotation, or detecting an unstable state.

The operation flow/algorithmic structure 900 may include, at 930, generating a report to disable the TCI state. The UE may generate a report that includes an indication of the TCI state and a request whether to disable the TCI. The request may be implicit or explicit.

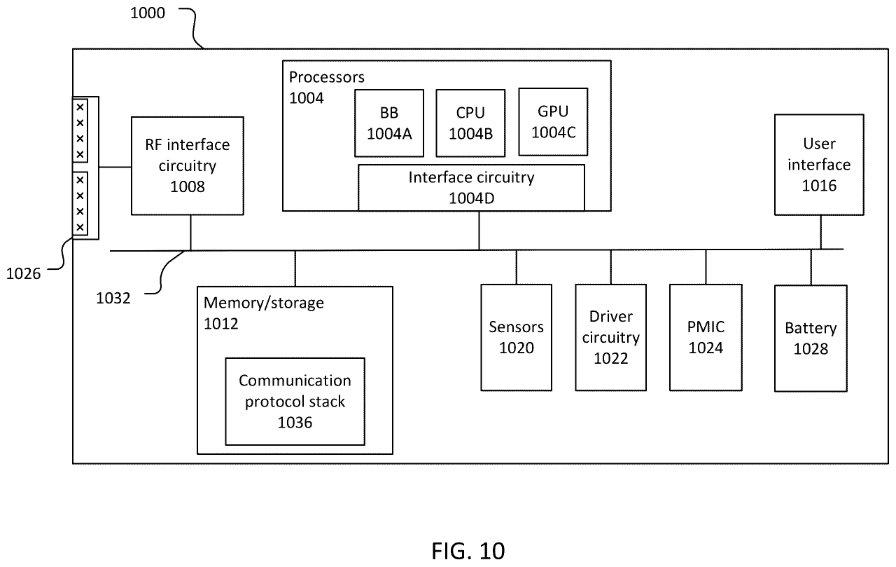

FIG. 10 illustrates a UE 1000 in accordance with some embodiments. The UE 1000 may be similar to and substantially interchangeable with the UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform delay-adaptive operations as described herein. The processors 1004 may also include interface circuitry 1004D to communicatively couple the processor circuitry with one or more other components of the UE 1000.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various delay-adaptive operations described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor circuitry 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

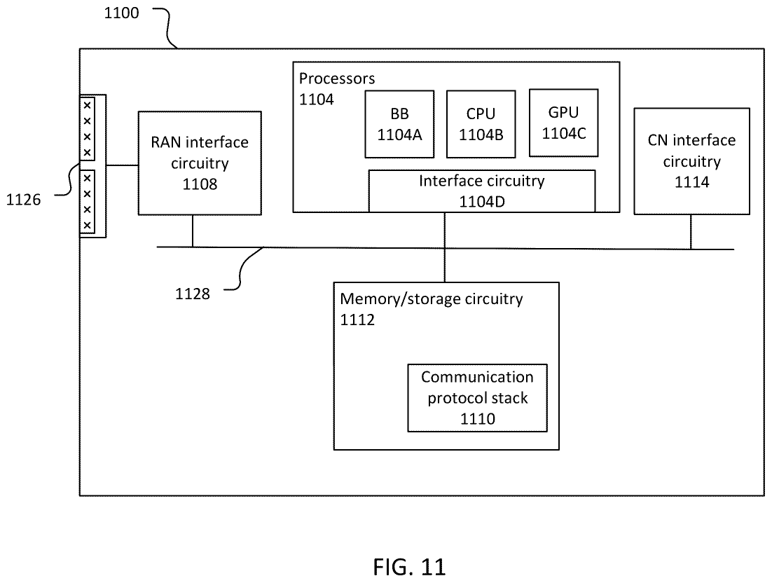

FIG. 11 illustrates a network device 1100 in accordance with some embodiments. The network device 1100 may be similar to and substantially interchangeable with base station 108.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the UE 1100 to perform delay-adaptive operations as described herein. The processors 1104 may also include interface circuitry 1104D to communicatively couple the processor circuitry with one or more other components of the network device 1100.

The CN interface circuitry 1114 may provide connectivity to a core network, for example, a 5th Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method including: detecting that each transmission configuration indicator (TCI) state of one or more active TCI states fails; determining a beam failure based on the said detecting that each TCI state of one or more active TCI states fails; and generating a beam failure recovery request, to be sent to a base station, in response to the beam failure.

Example 2 includes the method of example 1 or some other examples herein, the method further including: determining a TCI state failure based on a signal-to-interference-and-noise ratio (SINR) associated with the TCI state being lower than a first threshold or a reference signal received power (RSRP) associated with the TCI state being lower than a second threshold.

Example 3 includes the method of examples 1 or 2 or some other examples herein, the method further including: processing a configuration including the first threshold or the second threshold.

Example 4 includes the method of any of examples 1-3 or some other examples herein, the method further including: performing a measurement; determining whether each TCI state of the one or more active TCI states fails based on the measurement; wherein said determining whether each TCI state of the one or more active TCI states fails includes determining that each TCI state of the one or more active TCI states fails, and the method further comprises: incrementing a value of a counter; and wherein said determining whether each TCI state of the one or more active TCI states fails includes determining that each TCI state of the one or more active TCI states do not fail, and the method further comprises: resetting the value of the counter.

Example 5 includes the method of any of examples 1˜4 or some other examples herein, wherein said determining the beam failure further includes: determining the beam failure based on the value of the counter being equal to or greater than a threshold.

Example 6 includes the method of any of examples 1-5 or some other examples herein, wherein said generating the beam failure recovery request further includes: processing a configuration, received from the base station on a first serving cell, the configuration including a downlink (DL) candidate TCI state associated with a second serving cell; determining that the DL candidate TCI state is not valid based on a signal-to-interference-and-noise ratio (SINR) associated with the DL candidate TCI state being lower than a first threshold or a reference signal received power (RSRP) associated with the TCI state being lower than a second threshold; and generating the beam failure recovery request, to be transmitted to the base station using the DL candidate TCI state.

Example 7 includes the method of any of examples 1-6 or some other examples herein, wherein the beam failure recovery request is to be transmitted on a physical random access channel (PRACH) of a primary cell (PCell).

Example 8 includes the method of any of examples 1-7 or some other examples herein, wherein the beam failure recovery request is to be transmitted by a medium access control (MAC) control element (CE) of a secondary cell (SCell).

Example 9 includes the method of any of examples 1-58 or some other examples herein, wherein the beam failure recovery request is to be transmitted on a physical uplink control channel (PUCCH) or a physical random access channel (PRACH) using a TCI state associated with a physical downlink control channel (PDCCH).

Example 10 includes the method of any of examples 1-9 or some other examples herein, further including: determining a strongest TCI state of one or more physical downlink control channel (PDCCH) TCI states based on a signal-to-interference-and-noise ratio (SINR) of the strongest TCI state being greater than or equal to SINR of every TCI state of the one or more PDCCH TCI states or a reference signal received power (RSRP) of the strongest TCI state being greater than or equal to RSRP of every TCI state of the one or more PDCCH TCI states.

Example 11 includes the method of any of examples 1-10 or some other examples herein, further including: processing an acknowledgment from the base station, associated with the beam failure recovery request, the acknowledgment including a candidate TCI state of a physical downlink shared channel (PDSCH); and processing a reconfiguration message based on the candidate TCI state, the reconfiguration message including one or more reconfigured TCI states.

Example 12 includes the method of any of examples 1-11 or some other examples herein, wherein: the beam failure recovery request is transmitted by a medium access control (MAC)-control element (CE); the MAC CE is associated with a first hybrid automatic repeat request (HARQ) process; the acknowledgment is a downlink control information (DCI) including a second HARQ process including a new data indicator (NDI) and a second identifier; the first identifier is equal to the second identifier; and the method further comprises: assuming that a value of the NDI is toggled.

Example 13 includes the method of any of examples 1-12 or some other examples herein, wherein the beam failure recovery request is transmitted by a physical uplink control channel (PUCCH) or a physical random access channel (PRACH), and the method further comprises: expecting to receive the acknowledgment after a predefined number of symbols from the transmission of the beam failure recovery request.

Example 14 includes the method of any of examples 1-13 or some other examples herein, wherein the predefined number of symbols is 28 symbols.

Example 15 includes a method including: detecting a beam change generating a trigger based on the detection of the beam change, the trigger to be sent to a base station, the trigger indicating a request for a transmission of an aperiodic channel state information (CSI) reference signal (RS); and performing a measurement based on a configuration associated with the trigger.

Example 16 includes the method of example 15 or some other examples herein, wherein the trigger is to be transmitted on a physical random access channel (PRACH), on a physical uplink control channel (PUCCH) using a scheduling request (SR), or by a medium access control (MAC) control element (CE).

Example 17 includes the method of examples 15 or 16 or some other examples herein, wherein the trigger includes a first indication associated with a receiver beam sweep or a second indication associated with a transmitter beam sweep.

Example 18 includes the method of any of examples 15-17 or some other examples herein, wherein the trigger includes the first indication associated with the receiver beam sweep, and said performing the measurement includes: performing the receiver beam sweep using a non-zero-power CSI-RS resource set including a repetition field having a value of ‘ON.’

Example 19 includes the method of any of examples 15-18 or some other examples herein, wherein the trigger includes the second indication associated with the transmitter beam sweep, and said performing the measurement includes: performing the measurement associated with the transmitter beam sweep based on a non-zero-power CSI-RS resource set including a repetition field having a value of ‘OFF.’

Example 20 includes the method of any of examples 15-19 or some other examples herein, wherein the trigger includes: an indication of a transmitter beam indicating a preference of a beam to be used for the transmission of the aperiodic CSI-RS; a transmission configuration indicator (TCI) state of one or more activated TCI states; a TCI state of one or more configured TCI states; a TCI state of one or more candidate TCI states for beam failure recovery; or a number of aperiodic CSI-RS resources in a non-zero-power-CSI-RS resource set having a repetition field with a value of ‘ON.’

Example 21 includes a method including: detecting a condition; and determining not to perform an open loop power control procedure based on detecting the condition.

Example 22 includes the method of example 21 or some other examples herein, wherein detecting a condition includes: detecting a change in beam quality that is larger than a first threshold and detecting a rotation of a user equipment (UE); detecting an increase in a pathloss estimate that is larger than a second threshold; or detecting a failure to perform a beam compensation procedure.

Example 23 includes the method of examples 21 or 22 or some other examples herein, wherein the condition is a rotation of a user equipment, and the method further includes: selecting an omnidirectional beam for transmissions or receptions.

Example 24 includes the method of any of examples 21-23 or some other examples herein, wherein the condition is a rotation of a user equipment, and the method further includes: generating a request to be sent to a base station to indicate to the base station to use a beam having a width larger than a threshold.

Example 25 includes the method of any of examples 21-24 or some other examples herein, wherein the request is to be sent to the base station on a physical random access channel (PRACH) or a physical uplink control channel (PUCCH).

Example 26 includes the method of any of examples 21-25 or some other examples herein, wherein the request is included in a medium access control (MAC) control element (CE) or a radio resource control (RRC) signaling.

Example 27 includes the method of any of examples 21-26 or some other examples herein, wherein the request is included in a user equipment assistance information (UAI).

Example 28 includes a method including: processing a configuration received from a base station associated with a transmission configuration indicator (TCI) state; detecting a condition; and generating a report to be sent to the base station, the report including an indication of the TCI state and requesting the TCI state be disabled.

Example 29 includes the method of example 28 or some other examples herein, wherein said detecting the condition includes: detecting a power back off or a blockage associated with the TCI state; detecting a rotation; or detecting an unstable state.

Example 30 includes the method of examples 28 or 29 or some other examples herein, wherein the report includes reference signal received power (RSRP) or signal-to-interference-and-noise ratio (SINR).

Example 31 includes the method of any of the examples 28-30 or some other examples herein, wherein the report indicates that the TCI state is disabled for receiving or for transmitting operations.

Another example may include an apparatus comprising means to perform one or more elements of a method described in or related to any of examples 1-31, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-31, or any other method or process described herein.

Another example may include an apparatus comprising logic, modules, or circuitry to perform one or more elements of a method described in or related to any of examples 1-31, or any other method or process described herein.

Another example may include a method, technique, or process as described in or related to any of examples 1-31, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-31, or portions thereof.

Another example may include a signal as described in or related to any of examples 1-31, or portions or parts thereof.

Another example may include a datagram, information element, packet, frame, segment, PDU, or message as described in or related to any of examples 1-31, or portions or parts thereof, or otherwise described in the present disclosure.

Another example may include a signal encoded with data as described in or related to any of examples 1-31, or portions or parts thereof, or otherwise described in the present disclosure.

Another example may include a signal encoded with a datagram, IE, packet, frame, segment, PDU, or message as described in or related to any of examples 1-31, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-31, or portions thereof.

Another example may include a computer program comprising instructions, wherein execution of the program by a processing element is to cause the processing element to carry out the method, techniques, or process as described in or related to any of examples 1-31, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples) unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
detecting that each transmission configuration indicator (TCI) state of one or more active TCI states fails;
determining a beam failure based on said detecting that each TCI state of one or more active TCI states fails; and
generating a beam failure recovery request, to be sent to a base station, based on said determining the beam failure.

2. The method of claim 1, further comprising:
determining a TCI state failure based on a signal-to-interference-and-noise ratio (SINR) associated with the TCI state being lower than a first threshold or a reference signal received power (RSRP) associated with the TCI state being lower than a second threshold; and
processing a configuration including the first threshold or the second threshold.

3. The method of claim 1, further comprising:
performing a measurement;
determining whether each TCI state of the one or more active TCI states fails based on the measurement;
wherein said determining whether each TCI state of the one or more active TCI states fails includes determining that each TCI state of the one or more active TCI states fails, and the method further comprises:
incrementing a value of a counter; and
wherein said determining whether each TCI state of the one or more active TCI states fails includes determining that each TCI state of the one or more active TCI states do not fail, and the method further comprises:
resetting the value of the counter.

4. The method of claim 3, wherein said determining the beam failure further comprises:
determining the beam failure based on the value of the counter being equal to or greater than a threshold.

5. The method of claim 1, wherein said generating the beam failure recovery request further comprises:
processing a configuration, received from the base station on a first serving cell, the configuration including a downlink (DL) candidate TCI state associated with a second serving cell;
determining that the DL candidate TCI state is not valid based on a signal-to-interference-and-noise ratio (SINR) associated with the DL candidate TCI state being lower than a first threshold or a reference signal received power (RSRP) associated with the TCI state being lower than a second threshold; and
generating the beam failure recovery request, to be transmitted to the base station using the DL candidate TCI state.

6. The method of claim 1, wherein the beam failure recovery request is to be transmitted by a medium access control (MAC) control element (CE) of a secondary cell (SCell).

7. The method of claim 1, further comprising:
determining a strongest TCI state of one or more physical downlink control channel (PDCCH) TCI states based on a signal-to-interference-and-noise ratio (SINR) of the strongest TCI state being greater than or equal to SINR of every TCI state of the one or more PDCCH TCI states or a reference signal received power (RSRP) of the strongest TCI state being greater than or equal to RSRP of every TCI state of the one or more PDCCH TCI states.

8. The method of claim 1, further comprising:
processing an acknowledgment from the base station, associated with the beam failure recovery request, the acknowledgment including a candidate TCI state of a physical downlink shared channel (PDSCH); and
processing a reconfiguration message based on the candidate TCI state, the reconfiguration message including one or more reconfigured TCI states.

9. The method of claim 8, wherein:
the beam failure recovery request is transmitted by a medium access control (MAC) control element (CE);
the MAC CE is associated with a first hybrid automatic repeat request (HARQ) process having a first identifier;
the acknowledgment is a downlink control information (DCI) including a new data indicator (NDI) and a second HARQ process, the second HARQ process having a second identifier;
the first identifier is equal to the second identifier; and the method further comprises:
assuming that a value of the NDI is toggled.

10. The method of claim 8, wherein the beam failure recovery request is transmitted by a physical uplink control channel (PUCCH) or a physical random access channel (PRACH), and the method further comprises:
expecting to receive the acknowledgment after a predefined number of symbols from the transmission of the beam failure recovery request.

11. An apparatus comprising:
processing circuitry to:
detect a beam change
generate a trigger based on the detection of the beam change, the trigger to be sent to a base station, the trigger indicating a request for a transmission of an aperiodic channel state information (CSI) reference signal (RS); and
perform a measurement based on a configuration associated with the trigger; and
interface circuitry coupled with the processing circuitry to enable communication.

12. The apparatus of claim 11, wherein the trigger is to be transmitted on a physical random access channel (PRACH), on a physical uplink control channel (PUCCH) using a scheduling request (SR), or by a medium access control (MAC) control element (CE).

13. The apparatus of claim 11, wherein the trigger includes a first indication associated with a receiver beam sweep or a second indication associated with a transmitter beam sweep.

14. The apparatus of claim 13, wherein the trigger includes the first indication associated with the receiver beam sweep, and to perform the measurement the processing circuitry is to:
perform the receiver beam sweep using a non-zero-power CSI-RS resource set including a repetition field having a value of ‘ON.’

15. The apparatus of claim 13, wherein the trigger includes the second indication associated with the transmitter beam sweep, and to perform the measurement the processing circuitry is to:
perform the measurement associated with the transmitter beam sweep based on a non-zero-power CSI-RS resource set including a repetition field having a value of ‘OFF.’

16. The apparatus of claim 11, wherein the trigger includes:
an indication of a transmitter beam indicating a preference of a beam to be used for the transmission of the aperiodic CSI-RS;
a transmission configuration indicator (TCI) state of one or more activated TCI states;
a TCI state of one or more configured TCI states;
a TCI state of one or more candidate TCI states for beam failure recovery; or
a number of aperiodic CSI-RS resources in a non-zero-power-CSI-RS resource set having a repetition field with a value of ‘ON.’

17. One or more non-transitory computer-readable media having instructions that, when executed, cause processing circuitry to:
process a configuration received from a base station associated with a transmission configuration indicator (TCI) state;
detect a condition; and
generate a report to be sent to the base station, the report including an indication of the TCI state and requesting the TCI state be disabled.

18. The one or more non-transitory computer-readable media of claim 17, wherein to detect the condition the instructions, when executed, further cause the processing circuitry to:
detect a power back off or a blockage associated with the TCI state;
detect a rotation; or
detect an unstable state.

19. The one or more non-transitory computer-readable media of claim 17, wherein the report includes reference signal received power (RSRP) or signal-to-interference-and-noise ratio (SINR).

20. The one or more non-transitory computer-readable media of claim 17, wherein the report indicates that the TCI state is disabled for receiving or for transmitting operations.
